(19) United States
(12) Patent Application Publication
(10) Pub. No.: US 2008/0243716 A1
(43) Pub. Date: Oct. 2, 2008

(54) Investment management system and method

(76) Inventors: Kenneth Joseph Ouimet, Scottsdale, AZ (US); Timothy Luke Ouimet, Scottsdale, AZ (US); Eric Nichol, Scottsdale, AZ (US)

Correspondence Address: GREENBERG TRAURIG (PHX), INTELLECTUAL PROPERTY DEPARTMENT, 2450 COLORADO AVENUE , SUITE 400E, SANTA MONICA, CA, 90404, US

(21) Appl. No.: 11/998,164

(22) Filed: Nov. 28, 2007

Related U.S. Application Data
(60) Provisional application No. 60/908,848, filed on Mar. 29, 2007.

(51) Int. Cl. G06Q 40/00; G06F 17/00

(52) U.S. Cl. 705/36 R

(57) ABSTRACT

Embodiments of the invention provide a method of managing investments including generating portfolios using a mathematical optimization algorithm with investment themes, assigning a different weight of the investment theme to the portfolios, and associating the portfolios with a theme-based efficient frontier. Another method can include providing an investment rules interface to develop exception-based investing rules and based on asset attributes in which the exception-based investing rules are managed by a user. The method can also include creating an asset hierarchy including class levels for each asset and developing the exception-based investing rules for the class levels by assigning a parent asset attribute for a first class level and assigning a child asset attribute for a second class level. The method can further include generating at least one optimized portfolio based on the exception-based investing rules and the asset hierarchy.

### RELATED APPLICATIONS

This application claims priority under 35 U.S.C. § 119 to U.S. Provisional Patent Application Ser. No. 60/908,848, filed on Mar. 29, 2007, the entire contents of which is hereby incorporated by reference.

### BACKGROUND OF THE INVENTION

The following paragraph provides the basic historical context for investment management in the financial assets area. The understanding that certain portfolios can be developed to yield specific returns while minimizing risk formed the basis of Modern Portfolio Theory (MPT), as developed by Markowitz in the 1950's. The use of computing power and software solutions has been integral in the further application of MPT to asset allocation and portfolio development products over the last several decades. Most current solutions available generally model portfolios with respect to MPT. The evolution of computer-aided solutions has proceeded on an ad hoc basis, with quantitative methodology being introduced on an as-needed basis tailored to specific clients or products, rather than as general solutions available to the average investor. These solutions have been typically viewed as too complex for the average investor, and as such, have not been made available for the broader investing environment. Research in the financial academic community has been conducted on complex financial systems in which complicated computational methodologies have been developed, but remain in the arena of academic research. Up to this point, no solutions are available which can bridge the gap between complex academic research and user-friendly portfolio development tools.

### SUMMARY OF THE INVENTION

In light of the above, it would be desirable to have an improved investment management system and method. The system would be useful to individual consumer/lay investors, and/or to investment professionals (e.g., either individually or in coordinated groups of investment professionals, for example, employed by an investment or merchant bank, or by a mutual fund or other investment company or financial institution).

Some embodiments of the invention provide a method of managing investments using a computer system. The method can include generating a first plurality of portfolios using a mathematical optimization algorithm with at least one investment theme, assigning a different weight of the at least one investment theme to each one of the first plurality of portfolios, and associating each one of the first plurality of portfolios with a theme-based efficient frontier. The method can also include generating the theme-based efficient frontier by displaying a second plurality of portfolios which provides a representation of forecasted returns based on inherent thematic allocations.

Embodiments of the invention can provide an investment management system including a merchant platform for investment services adapted to be connected to at least two investment service providers. One or more of the investment service providers can generate forecasting information including an asset identification and a forecast. The merchant platform for investment services can use the forecasting information to optimize at least one portfolio.

Another embodiment of the invention provides a method including providing an investment rules interface to develop exception-based investing rules and providing an investment rules interface based on asset attributes in which the exception-based investing rules are managed by a user. The method can also include creating an asset hierarchy including class levels for each asset and developing the exception-based investing rules for the class levels by assigning a parent asset attribute for a first class level and assigning a child asset attribute for a second class level. The method can further include generating at least one optimized portfolio based on the exception-based investing rules and the asset hierarchy.

### BRIEF DESCRIPTION OF THE DRAWINGS

For a more complete understanding of the invention, reference is now made to the following figures, wherein like reference numbers refer to similar items:

FIG. 1 is a block diagram of an investment management system according to one embodiment of the invention.

FIG. 2 is a diagram of a user profile interface.

FIG. 3 is a diagram of an input process interface.

FIG. 4A is a block diagram of a merchant platform for investment services according to one embodiment of the invention and FIG. 4B is a corresponding table.

FIG. 5 is an asset attribute table.

FIG. 6 is a contract management table.

FIG. 7 is a service provider forecast table.

FIG. 8 is an integrated asset forecast table.

FIG. 9A is a diagram of a standard asset hierarchy structure and FIG. 9B is an asset hierarchy table.

FIG. 10 is an investment rules interface table.

FIG. 11A is a diagram of a thematic asset hierarchy structure and FIG. 11B is a thematic asset hierarchy table.

FIG. 12 is a block diagram of a risk tolerance development process.

FIG. 13 is a block diagram of an asset-asset correlation matrix development process.

FIG. 14. is an asset-asset correlation matrix.

FIG. 15 is a diagram of a portfolio selection user interface.

FIG. 16 is a diagram of a wizard-driven graphical user interface for a portfolio selection process.

FIG. 17 a diagram of a graphical user interface for selecting a portfolio from a set of optimized portfolios.

FIG. 18 is a diagram of a specific portfolio displayed for review during a selection process.

FIG. 19 is a diagram of various aspects of a thematic portfolio refinement process, including a theme-based efficient frontier.

FIG. 20 is a diagram of a graphical user interface of standard asset class hierarchical structures and associated portfolio opportunity curves.

FIG. 21 is a diagram of a graphical user interface of thematic class hierarchical structures and associated portfolio opportunity curves.

### DETAILED DESCRIPTION

The following description and the drawing illustrate specific embodiments sufficiently to enable those skilled in the art to practice the system and method described. Other embodiments can incorporate structural, logical, process and other changes. Examples merely typify possible variations. Individual components and functions are optional unless explicitly required, and the sequence of operations can vary. Portions and features of some embodiments can be included in or substituted for those of others. The elements that implement the various embodiments of the system and method are described below, in some cases at an architectural level.

The processing described below can be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any type of memory as is conventional in the art. By way of example, such data can be stored in a temporary memory, such as in the RAM of a given computer system or subsystem. In addition, or in the alternative, such data can be stored in longer-term storage devices, for example, magnetic disks, rewritable optical disks, and so on. For purposes of the disclosure herein, a computer-readable media can comprise any form of data storage mechanism, including existing memory technologies as well as hardware or circuit representations of such structures and of such data.

Embodiments of the invention and methods practiced according to the invention can be implemented using a variety of technologies. For example, the methods described herein can be implemented in software running on a programmable microprocessor, or implemented in hardware utilizing either a combination of microprocessors or other specially designed application specific integrated circuits, programmable logic devices, or various combinations thereof. In particular, the methods described herein can be implemented by a series of computer-executable instructions residing on a storage medium such as a CD-ROM, a disk drive, or other computer-readable medium.

The investment management system according to some embodiments of the invention allows investors to impose their own personal views, tilts, and themes into their portfolio development, down to the specific asset selection level, prior to the portfolio development and optimization process. For example, an investor who is environmentally conscious can impose his or her own personal environmental views into investment decisions into an integrated portfolio of assets without taking a piecemeal approach. The investment management system described herein permits the providing of a bridge for an investor who can have access to various information resources (e.g., a newsletter from an environmental group or industry advisor), but does not have a more systematic way to incorporate that information into personal investment decisions consistent with the development of a diversified portfolio of assets. Some embodiments of the invention address issues relating to portfolio returns, risk, taxes, or trading costs. Some embodiments of the invention provide the ability to input forecasts, the ability to accommodate multiple forecasts, the ability to forecast the potential impact on the portfolio, and the ability to incorporate these factors into the portfolio optimization process.

Some embodiments of the invention allow the user to view, understand, and interact with the strategic tradeoffs associated with risk, income needs, and other user-defined strategies. Some embodiments of the invention allow the typical investor to diversify to the individual asset level. Some embodiments of the invention provide for a comprehensive self-service individual investor model (whether online Internet or otherwise). Some embodiments of the invention are capable of extensive searching of a large universe of available assets, including specific equities, bonds, funds and ETF's, commodities, etc. Some embodiments of the invention produce specific “buy” and “sell” recommendations following proposed portfolio allocation development. Some embodiments of the invention account for related fees, costs, and taxes associated with investment activities. Some embodiments of the invention account for asset specific risk and return factors. Some embodiments of the invention allow the user to understand the methodology used to generate investment recommendations (e.g., buy/sell decisions and asset allocations). Some embodiments of the invention “un-bundle” investment management services, so that an investor is not forced make a take-it-all-or-leave-it decision with respect to the fund. For example, an investor can decide to invest in both an energy fund and a large cap fund. Both of these funds might, for example, have a significant allocation to Exxon Mobil stock, and the investor's portfolio after investing in these two funds would then have an undesirable and unexpected double-weighted allocation to Exxon Mobil stock. Some embodiments of the invention permit an investor to integrate the views of multiple managers and funds to develop a diversified portfolio representing multiple views of various investment information advisors and data services.

Due to the proliferation of information via the web, consumers are becoming increasingly empowered to direct their spending power towards products and services that are aligned with their individual moral and ethical views and themes. Investors have also been attempting to develop and align their individual investment decisions with personal views and themes. Some embodiments of the invention provide an individual investor a way to manage and direct his or her portfolio and investment activities. Consumers desire more control and simplicity, which results in a move towards self-service business models. Industries such as airline travel, consumer retailing, hotel reservations, and personal banking are continuing to evolve into web-based self-service models. Some embodiments of the invention embrace this trend by providing a self-service investment model. Social networking and wiki-based applications are rapidly growing, allowing users to interactively input their thoughts, views, themes, and intellectual contributions into many collaborative platforms, such as Wikipedia, Investopedia, etc. The era of defined benefit pension plans is rapidly fading away, as many companies have shifted to offering their workers defined contribution pension plans, such as the 401(k). While the defined benefit pension plan was administered either by the employer or their chosen administrator, most 401(k)'s are self-directed, with the employee making their own retirement investment decisions. This trend highlights the need for adequate tools for the average investor to use in managing his or her retirement investments. The world economy is increasingly intertwined due to globalization, and the ability to consider a broader universe of assets is desired in the development of a balanced portfolio. This can potentially maximize returns while minimizing risks, including risks that might be associated with a more insular approach.

In general, a system and method are described herein (e.g., a web-based, self-service investing system for individual investors or investment managers) that provides one or more of the features and aspects described in the following paragraphs, depending on the specific implementation. Some embodiments of the invention provide users with an interactive, web-based merchant platform for investment services where the user can interact with many various information service providers. This open architecture platform can act as a portal for both fee-based as well as free investing related information resources from service providers, which can include, but not be limited to the following: tax services, asset return forecasting services, asset information management services, brokerage services, financial intelligence services, charting services, and possible new services.

Some embodiments of the invention provide a platform with a standardized service architecture which allows service providers a consistent process (e.g., data interface) to act as a bridge through which the service provider's information can be incorporated by users into their individual investment decisions. Currently, investors must conduct research and subsequently determine how best to incorporate that information into their investment decisions.

Some embodiments of the invention permit users to integrate personal investment views and interests more seamlessly into their investment decisions. This system can also permit service providers and investors to better effect social change through more-coordinated investment decision making. This can benefit not only the user by satisfying their investment views and objectives, but can benefit a service provider by providing an interactive platform for it to inject its views into the investment decision-making process of a larger number of individual investors.

Some embodiments of the invention provide the investor the ability to control and tune his or her investment strategy. For example, the investor can design a portfolio to generate more income by simply turning an “income dial” (i.e., a user-interface symbol or structure that a user can vary, for example, using a mouse and a drag and drop motion), thus re-optimizing the portfolio, or adjusting the amount of risk they are willing to take for a forecasted return (displayed to the user, for example, on a computer LCD screen). This process can also allow the user to tune and adjust his or her strategic weightings of theme-based asset allocations in order to view the tradeoffs in overall investment return. For example, if an investor desires to weight his or her portfolio more heavily into a renewable energy theme versus traditional energy assets, the investor can observe the effects on the portfolio's expected performance visually (e.g., on a display in a browser or software program window) and adjust the investor's portfolio holdings accordingly (while viewing the corresponding portfolio return tradeoff).

Some embodiments of the invention allow users to define their investing strategies and rules within a graphical user interface. Some embodiments of the invention leverage mathematical optimization to design diverse portfolios which satisfy investor's rules and strategies. Some embodiments of the invention utilize in one approach a diagonal asset-asset correlation matrix that provides for fast measurement of the correlation matrix, as well as fast portfolio optimization. Some embodiments of the invention run “what-if” simulations which will graphically compare multiple portfolios, visualizing strategic tradeoffs.

Some embodiments of the invention provide for portfolio execution via an interface into a trading system by electronically sending the necessary “buy” and “sell” orders and trading rules to implement the selected portfolio. The merchant platform for investment services can permit service providers to sell research, and can permit mutual and hedge fund managers to de-bundle research from investment management services. For example, an investor deciding to invest in energy and large caps might subscribe to both energy and large-cap investing services. The services platform provides an approach for integrating these forecasts to develop a diversified forecast across the investor's full portfolio. This can provide new opportunities for the investor to integrate multiple best-of-breed investment advisor views and data sources across a broader universe of assets to create a well-diversified portfolio (while eliminating, for example, the double weighting that would result from simply investing in an energy mutual fund and a large cap mutual fund). Some embodiments of the invention review the historical performance of a portfolio.

The investment management system according to some embodiments of the invention includes a software platform for developing a diversified investment portfolio using an optimization process for making specific portfolio recommendations (in one embodiment, down to the individual asset level of detail).

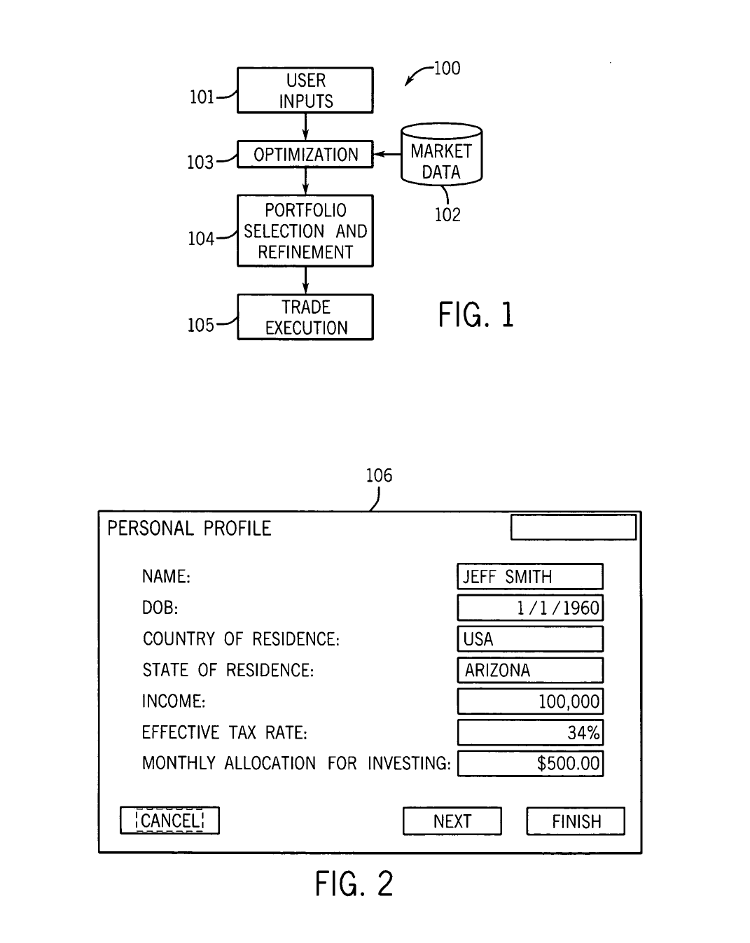

FIG. 1 illustrates an investment management system 100 according to one embodiment of the invention. The investment management system 100 can generally account for user inputs and market data in generating one or a multiple of potential portfolios, whereupon a user can select a portfolio (e.g., detailed down to the individual asset level), refine the selected portfolio if desired, and in some embodiments subsequently proceed to a trade execution process. In some embodiments, this platform is a web-based, self-service platform.

As shown in FIG. 1, an input process 101 allows for individual users to input initial information which can include, for example, user personal information, user investing rules, user existing portfolio data, and forecast estimates. A market data process or source 102 can provide data which can include, for example, asset specific trade data, such as bid/ask pricing, asset ticker, parent exchange, and asset-to-asset correlation information. Information and data provided in the input process 101 and the market data process 102 are subsequently used in an optimization process 103, in which one or more optimized asset portfolios are generated based upon the defining criteria input by the user.

Portfolios generated by the optimization process 103 can be presented to the user in the display process 104, whereby the user can select a specific portfolio from a number of proposed portfolios, and review the selected portfolio including specific assets and recommended share buy and sell amounts. The user can further refine the selected portfolio, if desired. The user can then accept the portfolio of their choice. In other embodiments, for example, an automated software program or agent can make selections for the user, or the selected portfolios and corresponding data can be sent to another system or site for further processing (e.g., as an input to an information system managed by a third party company not affiliated with the operator of the investment management system 100, and which can be accessed over the Internet).

In some embodiments, a trade process 105 allows for the user to proceed to a trade execution process whereby their entire portfolio can be implemented by carrying out the necessary buys and sells via brokerage resources of their choosing. In one embodiment, the trade executions can be automated (e.g., based on prior automation rules set by the investor). Each step of the above process is now described in more detail below.

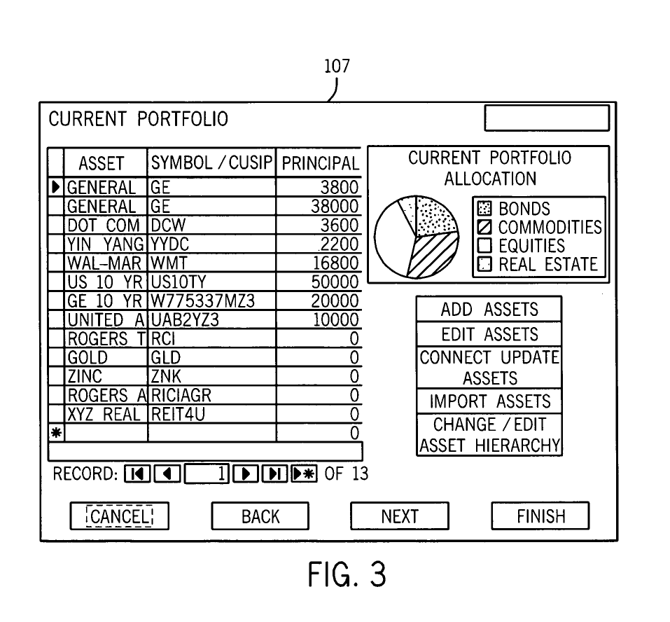

The user can have the ability, for example, to provide substantial input into the investment management system 100 by using a web-based graphical user interface, which can allow the user to direct the optimization process 103 by controlling investment parameters. Initially, users can input personal information into the input process 101, for example, via a user profile interface, as shown in FIG. 2. This information can include, for example, name, date of birth, residence, income, tax information, and other personal data. Users can also input their current portfolio, if applicable and desired, into the input process 101 via a current portfolio interface 107, as shown in FIG. 3. This information can include, for example, current assets held, ticker symbols, number of shares, and other asset related data.

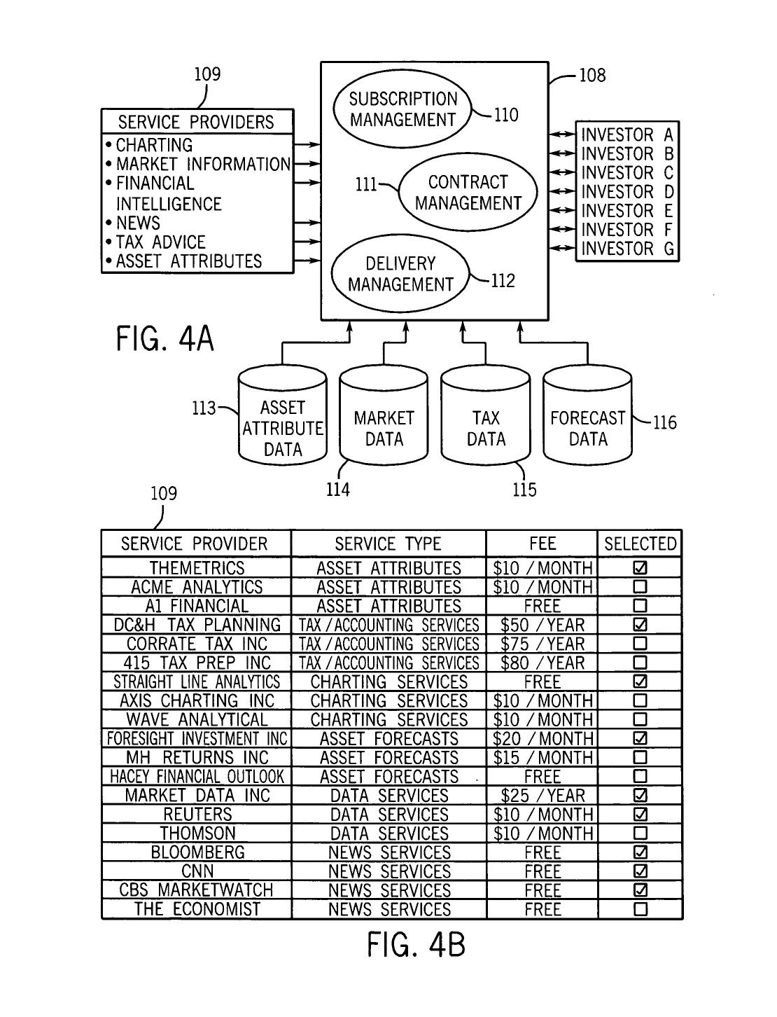

The input process 101 can also include a merchant platform for investment services 108 whereby the user can interact, as shown in FIG. 4A, with various investment service providers 109. The merchant platform for investment services 108 can act as a portal for incorporating, for example, both fee-based subscription services, as well as free information resources into the software platform. In some embodiments, the merchant platform for investment services 108 can permit information to be received into the system using a standard interface and which information can, at least in part, be used within the portfolio development process.

Software program modules can be used to manage subscription management (module 110), contract management (module 111), and/or delivery management (module 112) (e.g., delivery of investment services provider data, information, etc.). Information from the service providers 109 can be assimilated in various methods into the optimization process 103, which are described in more detail below. Information input by the user and otherwise received from third party information service providers 109 can be stored in one or more databases 113, 114, 115, 116 coupled to the merchant platform for management services 108. One or more processors (not shown) can be included in the merchant platform for management services 108 and can be configured (e.g., using software) for performing the calculations and optimizations discussed below.

Some general examples of hardware configurations that can be used for implementing the merchant platform for investment services 108 of FIG. 4A are now described. In some embodiments, a distributed computational architecture can be used whereby the user interfaces with a web server via the user's web browser (e.g., executing on a user's computer). In one embodiment, the system can include a web server, an investment services server, an application server, a database server, and one or more scientific-computation processing servers.

In some embodiments, a distributed data and computational architecture can be used. The user can interface with a web server via their web browser. In one embodiment, the system can include the web server, an investment services server, an application server, and one or more scientific-computation processing servers having database capabilities.

In some embodiments, a stand-alone application can be used. The user can host the application on the user's computer, which can receive data and information into the hosted application (e.g., received from a web server coupled to the user's computer over the Internet or another long-distance communication network). The user's computer can perform all or substantially all data storage and computational functions related to the methods described below.

In one form of assimilation, the user can, for example, select asset risk and return forecasts for incorporation into the merchant platform for investment services 108 for use in optimization process 103. Investment service providers 109 available on the merchant platform for investment services 108 can include, for example, but are not limited to: tax services, asset risk and return forecasting services, asset attribute information services, brokerage services, financial intelligence services, data vendors, charting services, news services.

The user can, for example, use a web-based graphical interface to review, select and subscribe to various services of his or her choosing. In one embodiment, a user can select (and typically subscribe) to specific information service providers 109. The user can then be allowed access to the information resources from those service providers 109, which can be integrated as an input into the portfolio optimization process 103 as described below.

As an example of the type of information a service provider 109 can furnish, an asset attribute information service can provide information rating various companies on their “environmental friendliness” (i.e., the extent of association of the company, and thus its stock asset, with the theme of “environmentally friendly”), and can rate the companies as shown in Table 1 below:

TABLE 1

| | | Attribute | |
|---|---|---|---|
| Asset | Attribute | Value | Scale/Units |
| Exxon Mobil | Environmentally Friendly | 17 | 1-100, 100 best |
| Halliburton | Environmentally Friendly | 22 | 1-100, 100 best |
| Evergreen Solar | Environmentally Friendly | 91 | 1-100, 100 best |
| Sunpower Corp. | Environmentally Friendly | 93 | 1-100, 100 best |

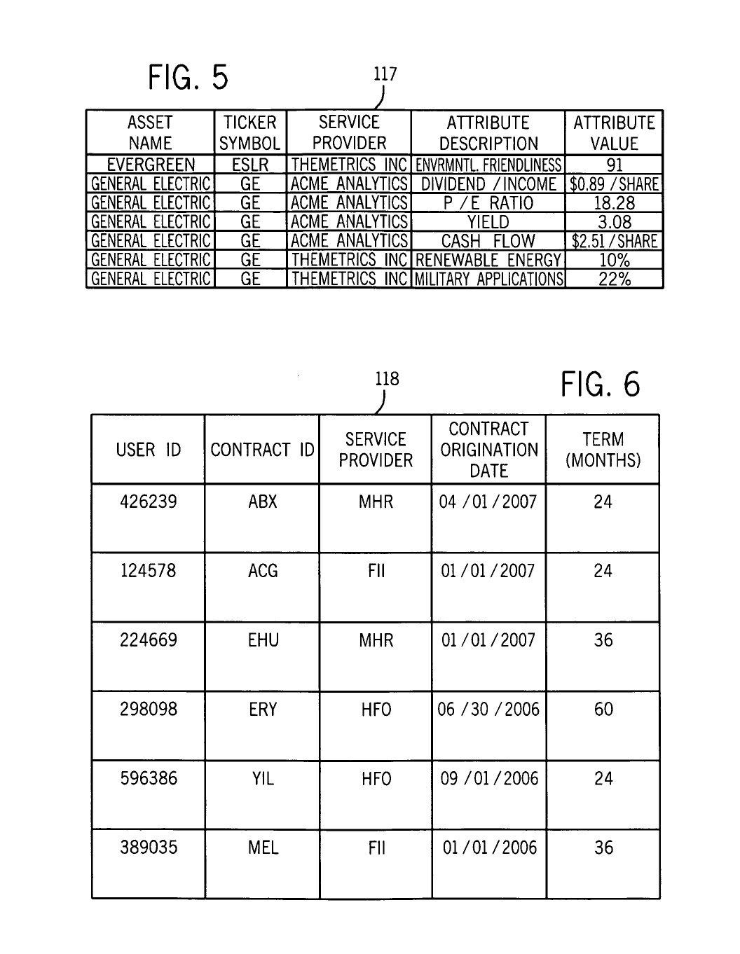

The attribute values (e.g., numerical values) from many such service providers 109, for example as shown in Table 1 above, can subsequently populate, for example, an asset attribute table 117 as shown in FIG. 5. In other embodiments, other attribute data structures can be used. The merchant platform for investment services 108 is a portal by which attribute information on assets can be received into the management system 100. This information can be provided or developed into asset specific attributes which can be used within the portfolio selection and refinement process, as described further below. Assets can be described by various attributes. Assets have typically been described using standard “financial” attributes, such as dividend, P/E ratio, yield, cash flow, etc. Assets can also be described in a “thematic” format, as shown in the asset attribute table 117, using as examples environmental friendliness, renewable energy, military applications, nuclear power applications, etc.

The merchant platform for investment services 108 can thus serve as an interactive medium in which users and service providers interact by the user's subscribing to services (e.g., by entering into service contracts online through the management system 100) and the advisors providing information flows (e.g., automated or manually-initiated) to the platform 108. In order to manage these contracts, the management system 100 can provide for the management of contract information, such as that shown in the contract management table 118 in FIG. 6.

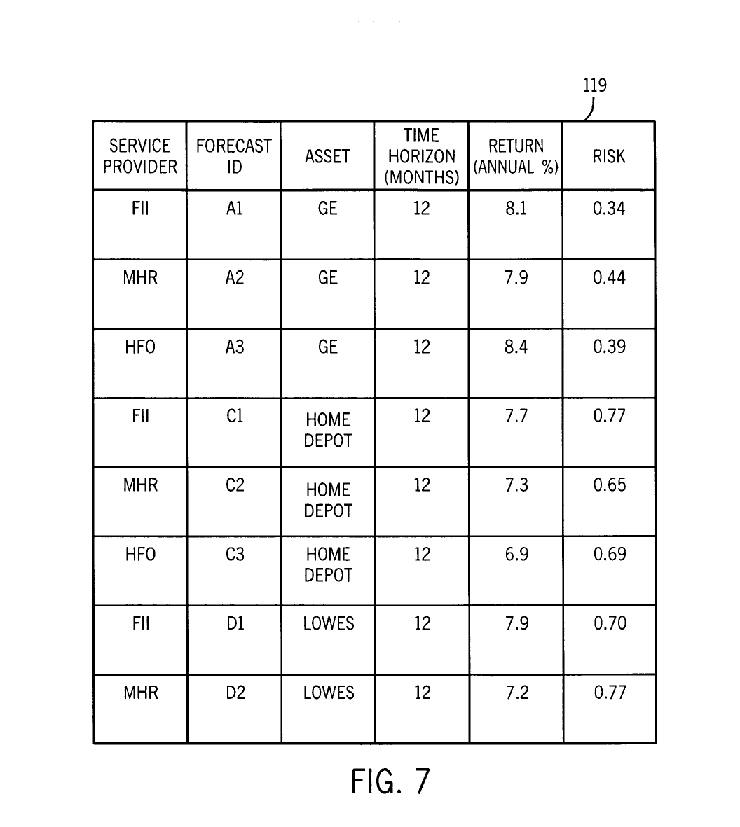

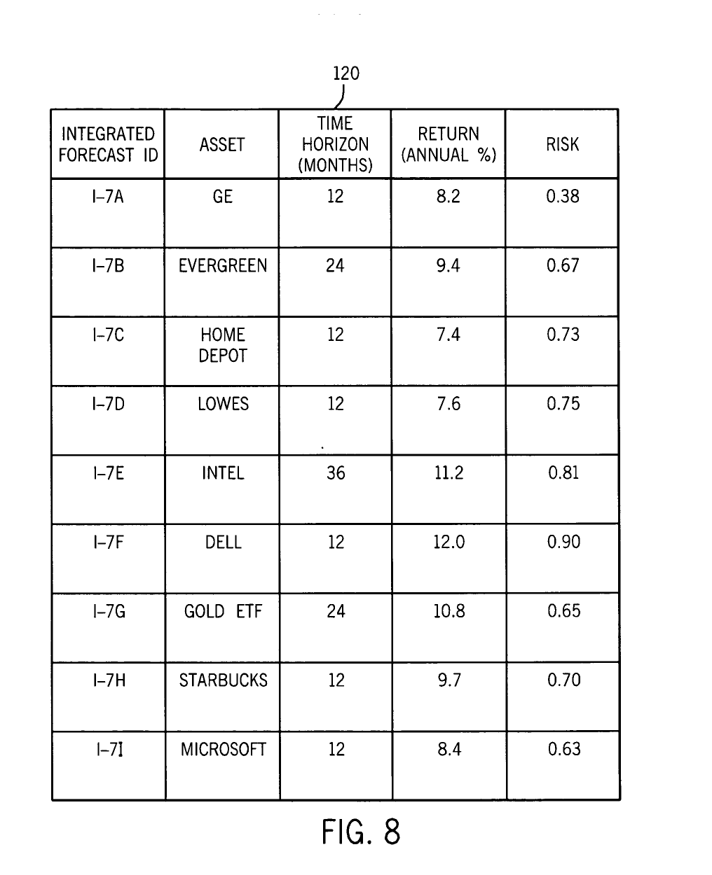

As mentioned in the example above, users can select and subscribe to, for example, specific asset risk and return forecasting services 109. In one embodiment, these expert asset risk and return forecasting services 109 can provide their data to the merchant platform for investment services 108, and the data can be stored, for example, in the form of a service provider forecast table 119, as shown in FIG. 7. In one embodiment, a user can desire multiple forecasts from various asset risk and return forecast services 109. In such a case, the forecasts can be combined and integrated into one forecast for a specific asset. One method is to calculate a simple mathematical average of the forecasts to generate an overall forecast. In one embodiment, a Bayesian methodology can be used to integrate multiple asset risk and return forecasts into one numerical forecast. Such integrated forecasts can then populate an integrated asset forecast table 120, as shown in FIG. 8. Other integrated asset data structures can be used in other embodiments.

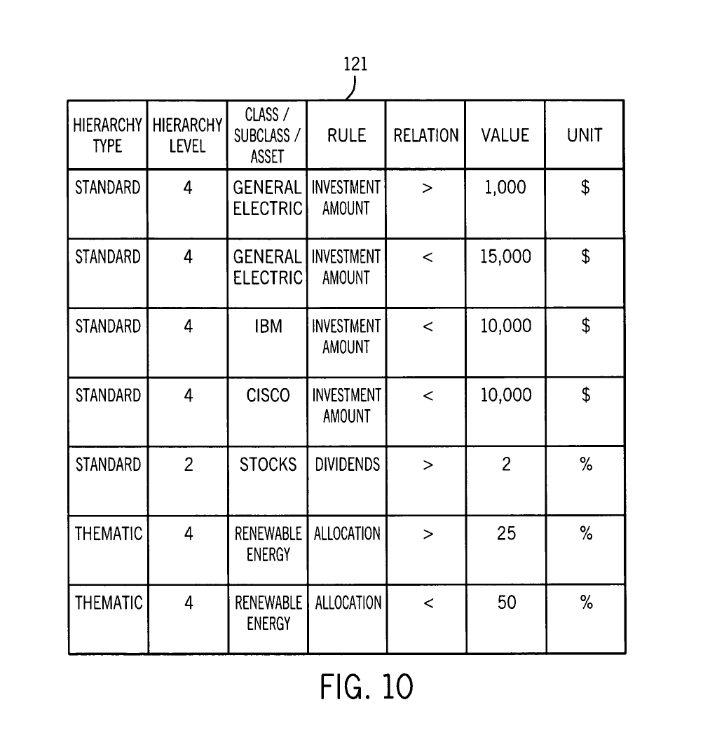

At this point in the investment management process, the user has input, for example, his or her personal profile, their current portfolio, if applicable, and selected information from various sources via the merchant platform for investment services 108. The user can now select investment rules (e.g., via an investment rules interface 121, as shown in FIG. 10) that will be used in and bound the later optimization process.

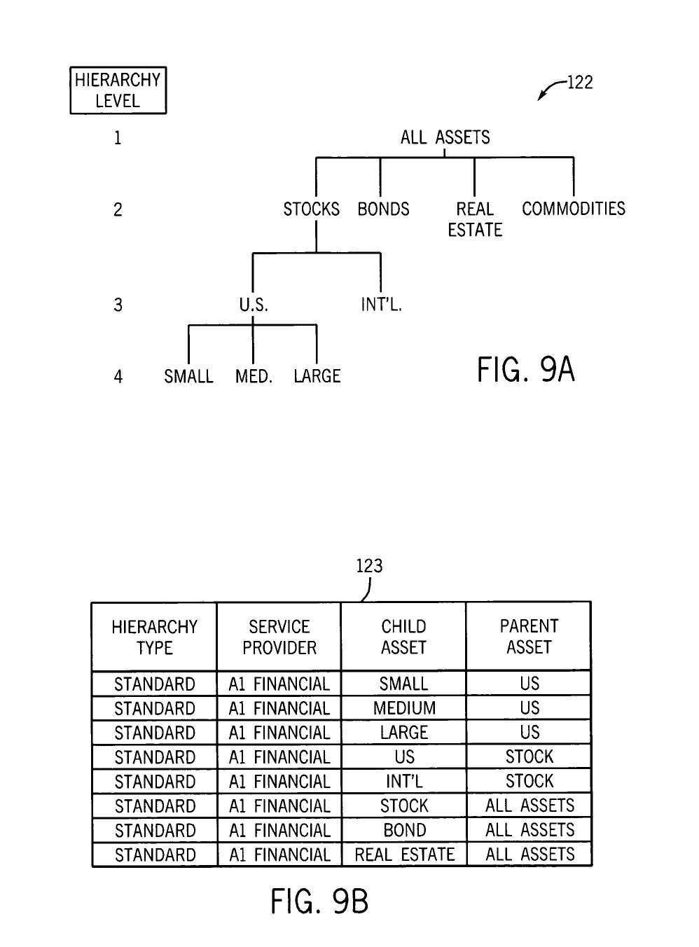

In order to set investing rules, the user can use an investment asset class hierarchy as a reference for which the investing rules can be set. In one approach, the user is presented with a default asset class hierarchy 122, as shown in FIG. 9A. The default asset class hierarchy 122 shows, for example, that all assets can be broken down from the major class levels, such as stocks, bonds, real estate and commodities, to subsequently lower levels, such as stocks being broken down into US stocks and international stocks, US stocks into small, medium, and large cap, etc. In an alternative embodiment, the user can be presented with an interface and tool that permits creating a user-defined asset hierarchy. For example, the user can select from a set of hierarchies presented and then do further user-customization using the tool. In other embodiments, the user can simply be provided the default asset class hierarchy 122 for use (e.g., for first-time or novice users).

Exception-based investing rules can be set by the user for each of the hierarchical asset levels, as shown in the investment rules interface 121 of FIG. 10. These rules can involve assigning asset attributes, as described herein, to various assets by the service providers 109 (e.g., the environmental ranking of an asset, the cash flow of an asset, the yield of an asset, etc.). The rules can then act on specific assets at the most-detailed level in the hierarchy and/or to asset classes on a more coarse (or higher) level in the hierarchy.

For example, if a user desires to only select assets with an environmental attribute value of 50 or greater, the user can set this rule (thus, only assets with this attribute value >=50 will be considered for inclusion in the optimized portfolio(s) presented to the user). If a user desires to select only US stocks, the user can set this rule (thus, assets flagged with the attribute of “International”, which can be information provided from a service provider, will similarly not be considered for inclusion in the optimized portfolio). In other words, the investing rules can be set on various layers of the hierarchies, whereby a user could set a rule, for example, that only US stocks are to be considered, and then set a more specific rule that of those US stocks, only those with environmental rankings >=50 be considered. For illustrative purposes only, an asset hierarchy table 123 is presented in FIG. 9B. The asset hierarchy table 123 lists the corresponding parent asset class for child asset classes in the default asset class hierarchy 122 illustrated in FIG. 9A.

A representation of the investment rules interface 121 is shown in FIG. 10, in which exception-based rules for the hierarchical levels are developed. An example is shown in which the user defines a rule at the individual asset level, which is “hierarchy level 4” in which no more than $10,000 of IBM stock is to be considered for inclusion in any optimized portfolio presented to the user after the optimization process 103. As mentioned above, the user can select or be provided a default asset class hierarchy 122, which can be, for example, that shown in FIG. 9A. FIG. 10 also illustrates thematic hierarchy types, which are discussed below. Exception-based rules can be set for thematic hierarchy types similarly as for the standard hierarchy types discussed above.

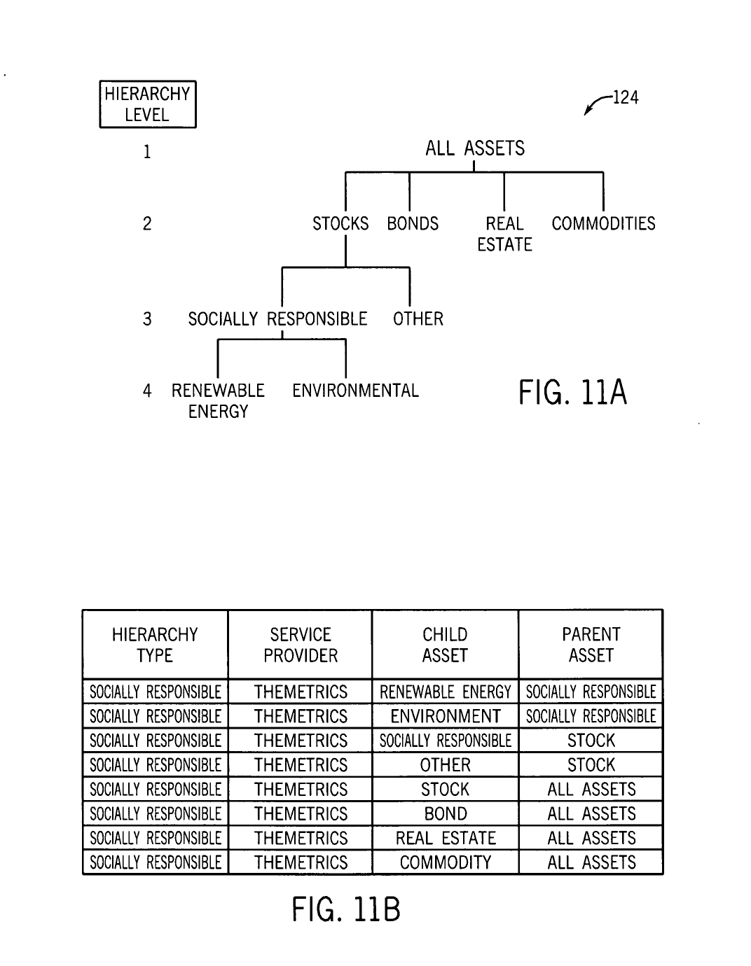

The user may also desire to set rules based on asset class hierarchies outside of the standard (e.g., traditional financial class) default asset class hierarchy 122 discussed above. An example of a non-standard asset class hierarchy is shown in FIG. 11A, which is referred to as a “thematic” asset hierarchy 124 (i.e., based on themes). In this example, the asset class “stocks” can be broken down at a lower level into themes such as “Socially Responsible” and “Other”. The “Socially Responsible” theme can subsequently be broken down into the themes of “Renewable Energy” and “Environmental”. In some embodiments, the user can set exception-based investment rules based on the asset class hierarchical structure 124 in place of the default asset class hierarchical structure 122. An example from FIG. 10 shows that a user can set a rule using the “thematic” hierarchy type 124, that greater than 25% but less than 50% of their portfolio be allocated to “Renewable Energy” assets (i.e., to assets associated with the “Renewable Energy” theme). An asset can be associated with one or more themes by its attributes, as described below.

The thematic asset hierarchies 124 (e.g., provided by default or customized by the user) will typically depend on the types of information sources available that are related to those hierarchies. Information resources selected from the merchant platform for investment services 108 can permit attributes to be assigned to assets. These attributes can be used to set-up the thematic asset hierarchies 124. The user can then set rules based on these thematic hierarchies 124 similarly as was described earlier. In one embodiment, a user is permitted to develop his or her own asset class hierarchical structure based on asset attribute information obtained by the user from the merchant platform for investment services 108, and to base the user's investing rules on his or her self-defined hierarchical structure.

The investment management system 100 in general can allow the user to set investment rules at any hierarchical level, with various hierarchical level rules being allowed simultaneously for the user's portfolio development. In general, the investment management system 100 permits integrating both the standard hierarchy 122 and the thematic hierarchy 124. Other embodiments can add yet additional hierarchies, or use only a single hierarchy (which might combine both standard and thematic elements).

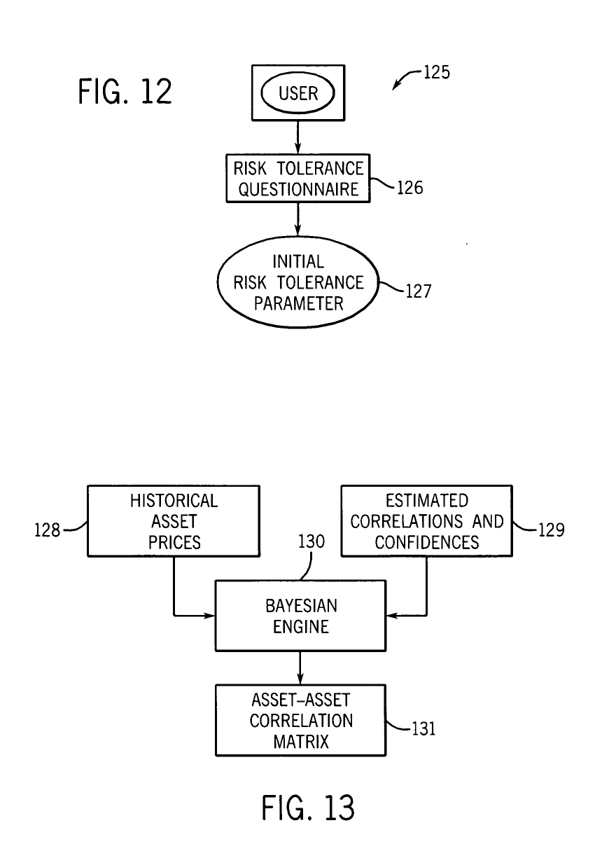

Users can optionally develop an initial risk profile 125, as shown in FIG. 12, which can include, but not be limited to, an investment risk tolerance questionnaire 126 or another method which can allow for the quantification of an initial risk tolerance parameter or domain 127. In one embodiment, an initial risk scenario can be displayed to a user to initially define his or her risk tolerance profile at a coarse level. Next, a risk scenario with more detail can optionally be presented to the user, which would further refine the user's risk tolerance profile. Subsequent steps, each providing more narrowly-defined risk tolerance scenarios, would finally permit the system to converge down to a substantially-detailed risk tolerance profile to provide a risk tolerance parameter 127 unique to that user. The risk tolerance parameter 127 can be graphically displayed to the user when the user views potential selected portfolios so the user can better understand the risk profile the user has defined by the foregoing process. If the user desires, for example, a greater portfolio expected return, the user can better visualize the need to accommodate more risk via this display within the graphical user interface.

User-input information (e.g., provided through a user interface 106, 107 in the input process 101) is directed into the optimization process 103. Market data from the market data process or source 102 is incorporated into the optimization process 103. This data can include, for example, but is not limited to, asset name, ticker symbols, bid and ask prices, and parent exchange information. As shown in FIG. 13, this market data can include historical asset price information 128, which can be combined with estimated confidence and correlation values 129 using a Bayesian methodology 130 to develop an asset-asset correlation matrix 131. In some embodiments, this procedure can include a methodology for determining the specific asset value correlative behavior between all individual assets. However, in other embodiments, this full extent of correlative behavior is not be required.

In one embodiment, the correlation process can use a method as set forth below in which a historical asset price 128 is accounted for by adjusting a model predicted value using error terms attributable to various sources.

$$\begin{matrix}\begin{matrix}\begin{matrix}\begin{matrix}{P}_{1 , t} = {\hat{P}}_{1 , t} ( 1 + {η}_{1 , 1} {ɛ}_{1 , t} ) \\ {P}_{2 , t} = {\hat{P}}_{2 , t} ( 1 + {η}_{2 , 1} {ɛ}_{1 , t} ) ( 1 + {η}_{2 , 2} {ɛ}_{2 , t} )\end{matrix} \\ {P}_{3 , t} = {\hat{P}}_{3 , t} ( 1 + {η}_{3 , 1} {ɛ}_{1 , t} ) ( 1 + {η}_{3 , 2} {ɛ}_{2 , t} ) ( 1 + {η}_{3 , 3} {ɛ}_{3 , t} )\end{matrix} \\ ⋮\end{matrix} \\ {P}_{N , t} = {\hat{P}}_{N , t} [ ( 1 + {η}_{N , 1} {ɛ}_{1 , t} ) ( 1 + {η}_{N , 2} {ɛ}_{2 , t} ) ( 1 + {η}_{N , 3} {ɛ}_{3 , t} ) … ( 1 + {η}_{N , N} {ɛ}_{N , t} ) ]\end{matrix}$$

where:
P_{N,t}=the price of asset “N” at time t
\hat{P}_{N,t}=the model predicted price of asset “N” at time t
η_{i,j}=the correlation of asset “i′^{s}” forecast error with asset “j′^{s}” forecast error
ε²_{N,t}=the historical volatility for the model for asset “N” at time “t”

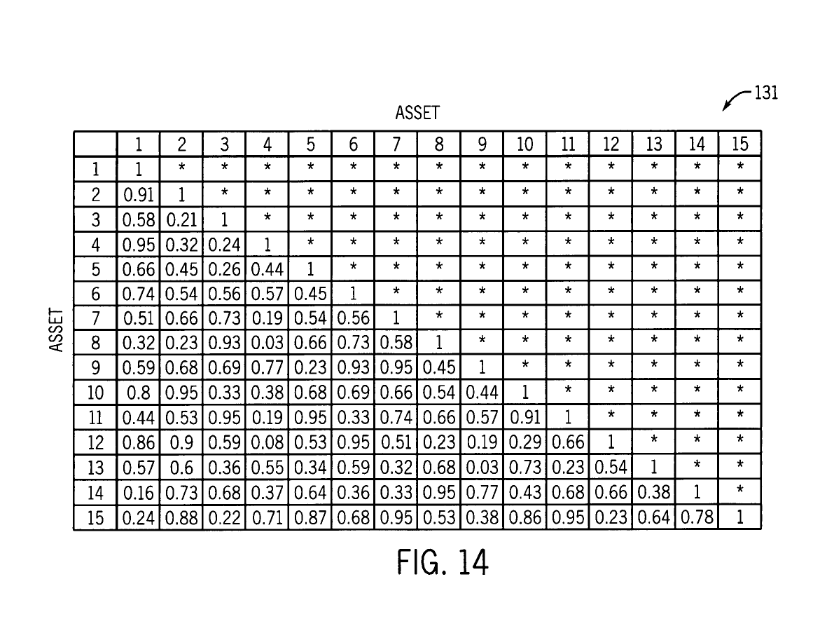

From this set of equations, a diagonal asset-asset correlation matrix 131, as shown in FIG. 14, can be developed in which asset correlation factors are calculated. This process uses a method utilizing scalable operations, which typically improves computational efficiency by defining a diagonal asset-asset correlation matrix 131.

The correlation values (“η_{i,j}” terms) from the asset-asset correlation matrix 131 are used as inputs to the objective function (see below) in the optimization process 103. More specifically, these values are used in the calculation of the historical correlated risk strategic measure, which is used as an input into an objective function in a process described below. Alternative embodiments of the invention can use other methods for determining the asset-asset correlation matrix 131. In one embodiment, the asset-asset correlation matrix 131 can be constructed using covariance values amongst assets. In another embodiment, the asset-asset correlation matrix 131 can be determined using a single or multiple factor model.

The optimization process 103 can determine optimal asset allocations which maximize user-defined strategies while satisfying user-defined rules and constraints. An objective function is constructed, as shown below.

$$F [ \{ a \} ] = {\sum }_{i} {a}_{i} {r}_{i} + {\sum }_{s} {λ}_{s} {\sum }_{i} {H}_{s , i} - {\sum }_{i} {TC}_{i} ( {a}_{i} ) - {\sum }_{i} {TX}_{i} ( {a}_{i} )$$

where:
aᵢ=allocation ($) of the i^{th} asset
rᵢ=forecasted annual return of the i^{th} asset
λₛ=strategic weight of strategy “s”
H_{s,j}=strategic measure “s”
TC=trading costs
TX=taxes
with the allocation constraint:

$${\sum }_{i = 1}^{N} {a}_{i} = A$$

where:

### A=Total Investment ($)

N=Total number of assets

The objective function is maximized with respect to the allocation constraint. In maximizing the objective function, the process permits conducting a substantially exhaustive search when adjusting the aᵢ terms. This process yields all aᵢ terms which are optimized for the multitude of strategies specified by the user as described herein. This objective function is one methodology which can be used, but those skilled in the art can implement a variety of other known methods for optimization (i.e., a different objective function can be used in alternative embodiments of the investment management system 100). In another embodiment, an objective function can be constructed to account for risk and return only, without the complications of accounting for multiple strategies, taxes, and trading costs.

A specific example of a set of strategies is now described with reference to Table 2 below. The strategies (designated by the notation “s”) and their corresponding descriptions and measures can include, but are not limited to, those shown in Table 2 below. Table 2 is merely one of many sets of strategies that can be employed by any given user.

The strategies are typically determined by the user's interaction with the merchant platform for investment services 108 and the investment rules interface 121. In one embodiment, the types of information services the user selects within the merchant platform for investment services 108 can determine the strategies. For example, if the user selects information from a service provider 109 on corporate rankings for environmental friendliness, then “Environmental Friendliness” can be used as a strategy. There can also be a default set of strategies for the user to select. Attribute values provided by the service providers 109 can be used to populate the asset attribute table 117, as described earlier.

In some embodiments, the user can also have the option to define strategies within the investment rules interface 121. These steps can be iterative as the user can wish to have additional strategies to select or control after an initial selection of services from one or more investment service providers 109. For example, if a user initially selects providers 109 to provide information on assets for the strategies of Country of Origin, Corporate Governance, and Defense Industry-Related, and then subsequently desires to obtain information from a service provider 109 for assets that are Environmentally Friendly, the user can subsequently modify the strategies selection in the merchant platform for investment services 108 so that information on environmentally friendly asset rankings will be provided, thus making that strategy available to the user. The user can then set investment rules using the Environmentally Friendly attribute within the investment rules interface 121, as was described earlier.

TABLE 2

| Strategy | Strategy “s” | | Strategic Measure |
|---|---|---|---|
| # | Description | Strategic Type | H_{s,i} |
| 1 | Historical CorrelatedRisk | Financial | ${( {\sum }_{k = 1}^{i} {a}_{k} {η}_{k , i} {ɛ}_{i} )}^{2}$ |
| 2 | Forecast Uncertainty | Financial | aᵢσᵢ² |
| | Risk | | where σᵢ = standard |
| | | | deviation associated |
| | | | with the forecasted |
| | | | price of asset “i” |
| 3 | Income | Financial | Iᵢ |
| 4 | Liquidity | Financial | Lᵢ |
| 5 | Renewable Energy | Thematic | REᵢ |
| 6 | Defense Industry | Thematic | DIᵢ |
| 7 | Corporate Governance | Thematic | CGᵢ |
| 8 | Environmental Friend- | Thematic | EFᵢ |
| | liness | | |

As shown in Table 2, in general, two kinds of strategies can be described: (1) financial strategies, and (2) thematic strategies (i.e., strategies based on a theme). Financial strategies are those typical to many investors, such as portfolio risk, income, and liquidity. Thematic strategies have been established to allow the user to develop allocations based on investing themes they can find important, such as “Renewable Energy”, “Environmental Friendliness”, and other themes. The preceding table lists several strategies of both types as examples.

As used herein, a “theme” is generally a quality or characteristic of an asset. The use of one or more themes in investment management as described herein permits the integration of various sources of investment advice and other information, both of subjective and objective investment information, to aid in the selection of a desired investment portfolio(s).

The term “strategic measure” refers to the quantitative measure of the corresponding strategy. For example, the strategic measure for the strategy “Income” could be $0.25/share for a specific asset, and the strategic measure for the strategy “Environmental Friendliness” could be “91” (out of a scale of 1-100, for example) for a specific asset. The values for the strategic measures are drawn, in this example, from the asset attribute table 117 shown in FIG. 5, and the integrated asset forecast table 120 shown in FIG. 8.

The strategic measures are derived from the attribute values discussed above. In typical practice, the asset attribute values collected from various investment services providers 109 (e.g., as shown in FIG. 5) are expected to be of a wide and varied nature. Examples can include numerical values from a scale (e.g., scale of 1-100), alphabetical ratings (e.g., “AAA” to “CCC”) and possibly other forms of information. In one embodiment, attribute values can be formatted or normalized for use within the objective function as comparative mathematical terms. The conversion process from attribute value to strategic measure can vary depending on the implementation. For example, conventional normalization approaches can be used in which the values for the strategic measures are “derived” from the asset attributes by some form of mathematical normalization process such that they can be used in a mathematically comparative fashion within the objective function.

The term “strategic weight” (λₛ) refers to the weighting factors that are used within the objective function in developing optimized portfolios. These factors in effect lend a measure of “weight” to the strategic measures and can be adjusted to add or lessen the influence of the strategy in the development of portfolios for selection. In order for the optimization process 103 to generate multiple portfolios for a range of strategic measures, a range of strategic weights are used within the objective function to generate the portfolios. The process by which strategic weights are determined and used in one embodiment is now described below.

Initially, the strategic weights are, for example, set by default. The strategic weight values can be numerical ranges with preset steps and, for example, populate a strategic weight sampling table, as shown below in Table 3. An example of this table for three strategies is shown below in Table 3:

TABLE 3

| Strategy “s” | λ^{MIN} | λ^{MAX} | λ^{STEP} |
|---|---|---|---|
| 1 | 0 | 1 | 0.2 |
| 2 | 1 | 3 | 1.0 |
| 3 | 0 | 0.2 | 0.1 |

The number of strategies is determined by the user, as described earlier. Next, these strategic weight values populate a strategic weight table, which contains all of the combinations of the weights for the strategies, as shown below in Table 4.

TABLE 4

| Portfolio | λ for Strategy 1 | λ for Strategy 2 | λ for Strategy 3 |
|---|---|---|---|
| 1 | 0 | 1 | 0 |
| 2 | 0 | 1 | 0.1 |
| 3 | 0 | 1 | 0.2 |
| 4 | 0 | 2 | 0 |
| 5 | 0 | 2 | 0.1 |
| 6 | 0 | 2 | 0.2 |
| 7 | 0 | 3 | 0 |
| 8 | 0 | 3 | 0.1 |
| 9 | 0 | 3 | 0.2 |
| 10 | 0.2 | 1 | 0 |
| 11 | 0.2 | 1 | 0.1 |
| 12 | 0.2 | 1 | 0.2 |
| etc. | etc. | etc | etc |
| 72 | 1 | 3 | 0.2 |

As shown in the example in Table 4, there are 72 combinations of the strategic weights given for the example of Table 3. Each specific combination is designated as a portfolio, as indicated in the first column of Table 3.

The strategic weights for each portfolio are then input into the objective function, which through maximization as described above yields a unique optimized portfolio for those input strategic measures and weights. A tabular representation of the output from the objective function can be shown as follows in Table 5:

TABLE 5

| | | | | Strategic |
|---|---|---|---|---|
| | | Strategic | Strategic | Measure 3 |
| | | Measure 1 | Measure 2 | Environmental |
| Portfolio | Return (%) | Risk | Portfolio Income | Friendliness |
| 1 | 12.3 | 0.053 | $13,850 | 68 |
| 2 | 9.3 | 0.066 | $12,100 | 45 |
| 3 | 10.3 | 0.037 | $8,900 | 87 |
| 4 | 11.75 | 0.087 | $21,800 | 59 |
| etc. | etc. | etc. | etc. | etc. |
| 72 | 9.5 | 0.063 | $19,050 | 28 |

The values in Table 5 above are merely provided as examples, and the actual values used for or corresponding to any given embodiment or implementation will vary with the particular situation. Each portfolio has a portfolio return associated with each combination of strategic measures. These can, for example, be displayed graphically to the user (e.g., in a window of a computer monitor), which can show how portfolio return would vary with changes in the magnitudes of the various strategies and weights. A benefit of the mechanism described above is to provide the user the functionality to alter the weightings assigned to various strategies, and to interactively see (e.g., in the user interface window) how this affects the portfolio return. As described in the preceding discussion, the strategic weights are, for example, initially set by default, but can be manipulated or varied by the user to generate more precision in the development of portfolios for selection in optimization process 103. The portfolios can be displayed and reviewed in various fashions, as discussed in greater detail below.

Based upon the user's inputs into the input process 101 and the market data process or source 102, the optimization process 103 can develop multiple optimized potential portfolios for the user to review in the display process 104 and to typically select one individual portfolio (e.g., for implementing trades and other investment actions). The optimization process 103 in the one embodiment develops portfolios for a range of strategic weights, and presents those to the user for selection. The user can then select a specific portfolio using a variety of methods. The user can be provided an interface and process to review, filter, select, and refine the user's selected portfolio. The following discussion details how a user can proceed to the final portfolio selection step, in one embodiment, with avenues for iteration available.

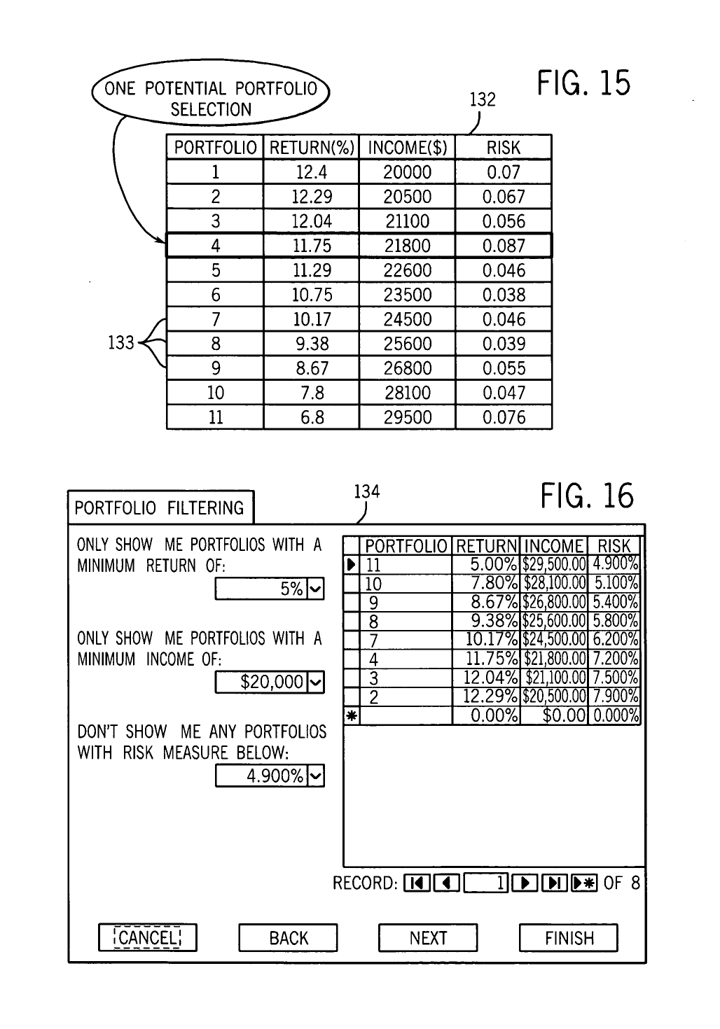

The user can view (e.g., via a graphical user interface) multiple portfolios, at which point the user can scan through several or all of the optimized portfolios. The optimized portfolios can be presented in various ways in the graphical user interface. One method for presenting the optimized portfolios can utilize a tabular format 132, as shown in FIG. 15, whereby a user is presented all optimized portfolios 133. The user can scan through the choices and select a portfolio, in which case the display can present to the user (e.g., in a separate window) a more detailed description of the portfolio recommended assets, as well as other relevant portfolio data of interest to the user. In FIG. 15, the portfolio selected (indicated as “4”) shows, for example, the specific return, income and risk associated with that portfolio.

Due to the potential for the optimization process 103 to generate a substantial number of optimized portfolios 133 sometimes yielding a long and complex tabular representation 132 like that in FIG. 15, a graphical or wizard-driven approach can be used in some embodiments to simplify the portfolio selection process for the user. Such types of approaches will assist the user in visualizing strategic tradeoffs when comparing various optimized portfolios 133 generated. FIG. 16 illustrates a possible representation of a wizard-driven approach 134 through the graphical user interface. The user is initially presented with the totality of optimized portfolios 133, but is subsequently guided through a process where a series of wizards and drop-down menus can guide the user through the process of filtering through the portfolios available, until the best available options remain for final user selection. The user can then select one specific portfolio satisfactory to the user's individual strategic investment goals.

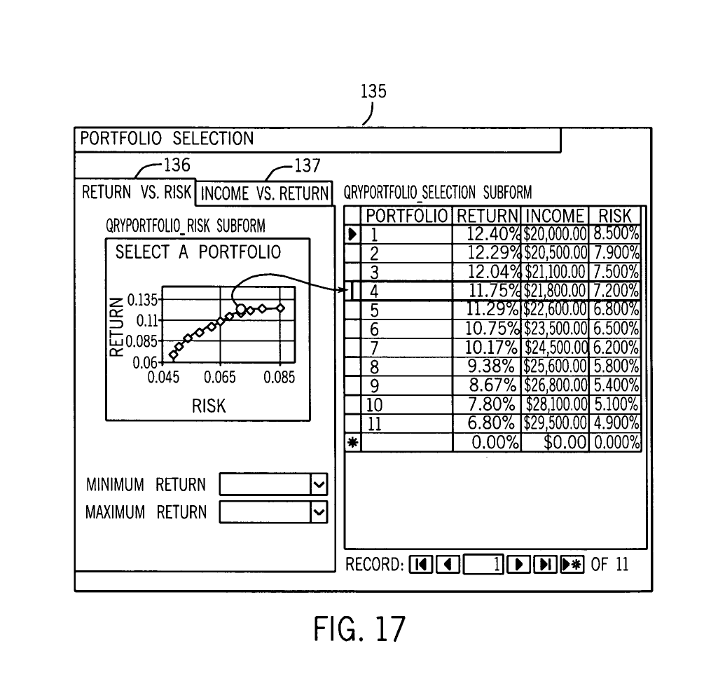

FIG. 17 illustrates a possible representation of an optional graphical approach 135 to assist the user in selecting a portfolio from a set of optimized portfolios 133. In this approach, the user views multiple portfolios where, for example, portfolio risk versus return 136, income versus return 137, and/or other investment strategies (e.g., defined in the input process 101) are represented graphically to the user (e.g., in the same user-interface window). The user can interact with the graphs, for example, through the use of a slider or other mechanism, to select a portfolio consistent with the user's strategic investment targets.

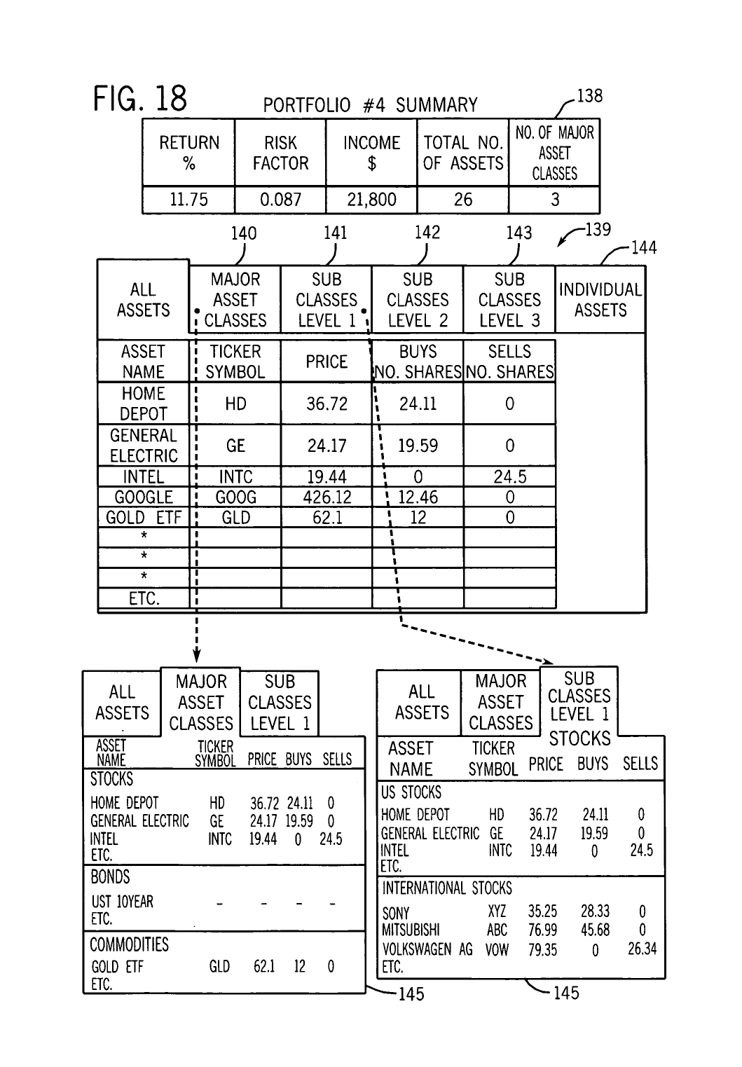

Once the user selects a specific portfolio, the portfolio can then be displayed, for example as shown in FIG. 18, in which the user can, for example, view a brief summary 138 of the portfolio data, as well as view the various hierarchical levels 139 of the portfolio, from the major asset classes 140 down through asset sub-classes 141, 142, 143, finally to the individual asset level 144. FIG. 18 also depicts a tabular interface 145 permitting the user to more simply navigate amongst the various hierarchical levels to view the portfolio at the various class levels.

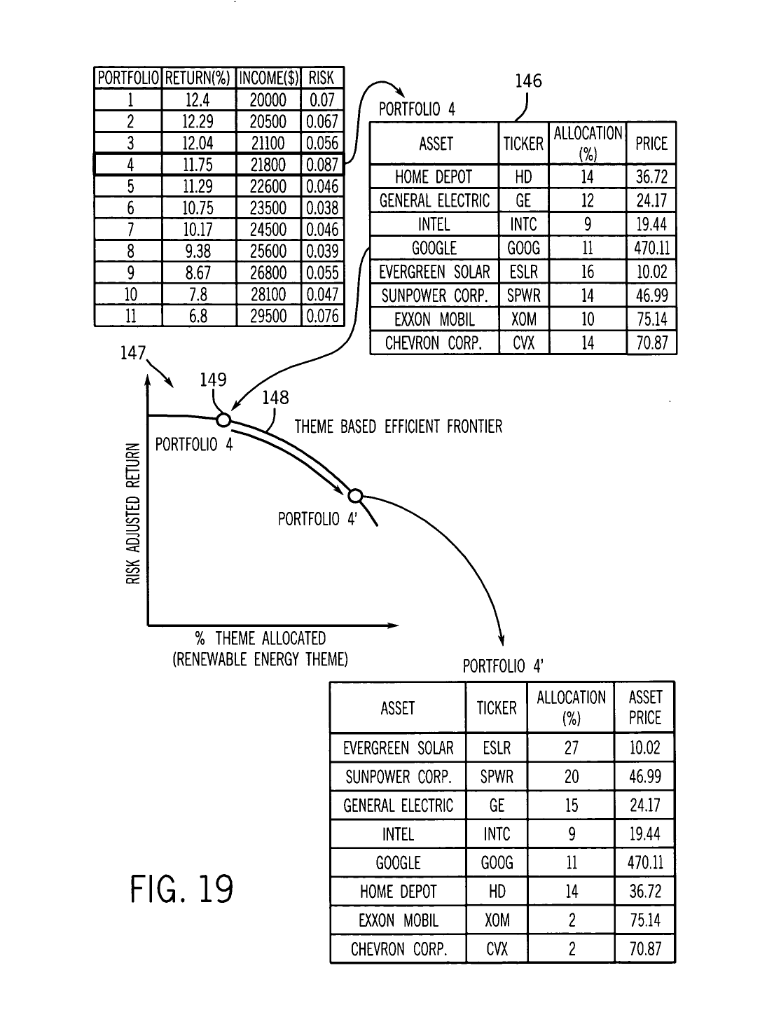

Using the data, information, and method described above, the process has developed multiple portfolios from which the user can view, filter, and select. Further refinement and interaction can now occur using the concept of the theme-based efficient frontier. In some embodiments, the theme-based efficient frontier is a method for displaying a plurality of portfolios which provides a representation of their forecasted returns based on their inherent thematic allocations. This is distinguished from the existing state of the art developed within Modern Portfolio Theory (MPT). Once the user has selected a specific portfolio to display in the display process 104, the user can further refine the strategic limitations and/or the rules-based numerical constraints to determine how such changes might alter the selected portfolio's allocations and other data, including, for example, portfolio return, overall risk, projected portfolio income, thematic allocations, as well as any other user defined strategies. In one embodiment, a user display (e.g., a user interface window) shows portfolio return versus a specific thematic allocation, as shown in FIG. 19. This display can include, for example, but not limited to, a tabular summary 146 of the selected portfolio's data, and a graphical view or representation 147 of the portfolio's opportunity curves 148, which is a theme-based efficient frontier and which illustrate where the selected portfolio lies along these curves 148. The theme-based efficient frontier, shown as opportunity curves 148, can provide a graphical display or other user interface that shows the user the tradeoffs between portfolio return and selected strategies. The user can view “what if” scenarios by adjusting the strategic values and interactively viewing the tradeoffs in return that would occur. In one embodiment, the opportunity curve 148 represents a theme-based efficient frontier for a specific portfolio.

The example in FIG. 19 shows that Portfolio 4 has a higher risk-adjusted return than Portfolio 4′, but that Portfolio 4′ can be chosen as it allocates a higher percentage of the portfolio towards renewable energy assets. In one embodiment, the optimization and portfolio selection processes generate numerous portfolios, so that moving the slider from Portfolio 4 to Portfolio 4′ does not require re-running the optimization process 103. Instead, the opportunity curve 148 can be generated from the stored portfolios already available. The user can travel along the opportunity curve 148 with a slider 149 or other mechanism and view the potential portfolios and related returns in making their decisions as to which portfolio and associated forecast return to accept. The curves 148 can include, for example, portfolio forecasted return versus risk, income, and any other user defined strategies as established, for example, in the user input interface process 101. By traveling along the curve 148, for example by using a user-interface point-and-click slider 149, the user can change the strategic weighting (λₛ) of that specific strategic measure. As an example, after the user moves the slider 149 to an 80% thematic allocation, the portfolio selection process uses the stored portfolios (with their stored corresponding strategic weights) to generate multiple portfolios for a range of user-selected strategic weights (which correspond to various thematic allocations).

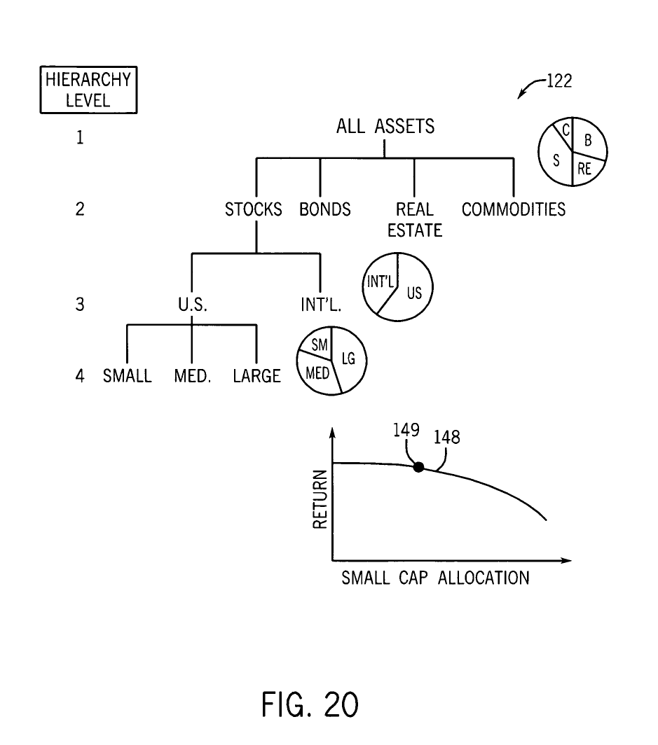

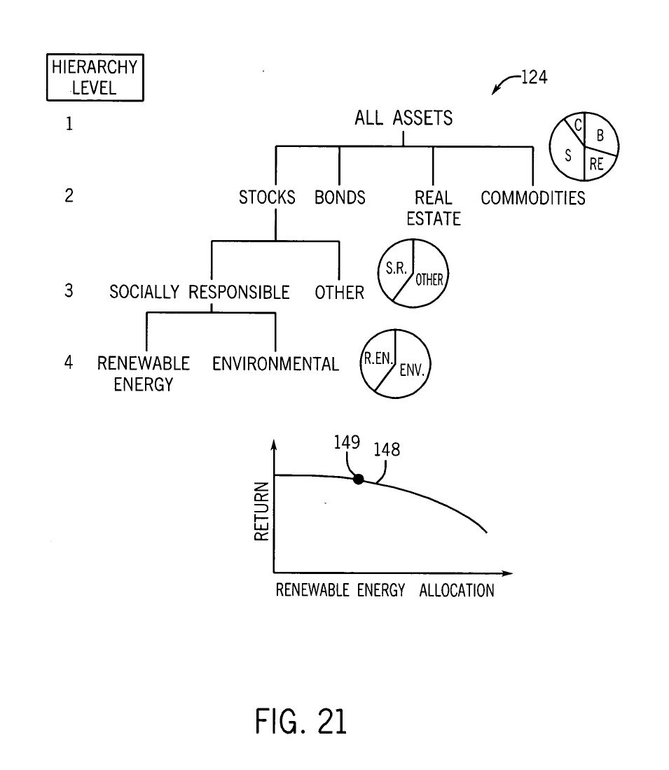

The portfolio refinement step can also include a process allowing the user to view a display of the hierarchical asset class structure of the portfolio, from the highest level of the overall portfolio, down through individual asset classes and sub-asset classes to the individual asset level. FIGS. 20 and 21 depict possible representations of the display within the graphical user interface showing possible asset class hierarchical structures 122, 124 with associated portfolio opportunity curves 148. In one embodiment, the user is able to manipulate opportunity curves at each hierarchical level (for each hierarchical class as can be selected by the user). The examples shown in FIGS. 20 and 21 present a representation whereby the user can view the related data for each level selected and alter the allocations presented, for example by using interactive graphs as described above. The user is then able to view the hierarchical asset class allocation changes as the strategic change is effected graphically.

For any alterations made to any allocations at any level in the hierarchy (standard 122 or thematic 124), the changes to the portfolio's data, including, for example, overall return, risk, and any other user defined strategies, can be shown to the user in a manner that compares the originally-selected portfolio's data to that of a user-refined portfolio, and summarizes the comparative tradeoffs for the user (not shown). In one embodiment, at any point in the foregoing portfolio review and refinement steps, the user is able to skip back to any prior step in order to alter their investment rules or other inputs (note that in other embodiments, there can be limitations placed on the user's ability to skip backwards in the process). This iterative approach permits the user to control the overall portfolio development and optimization process 103 and to obtain portfolio results with the ability to refine and re-optimize towards a final desired user portfolio.

Once the user has completed the portfolio selection and refinement using the display process 104, the user is then optionally directed to trade execution process 105 whereby the selected portfolio can be initiated by executing the necessary trades. One approach for trade execution is permit the user to direct himself or herself to a selected brokerage for implementing his or her selected portfolio and associated trade orders.

The system and method for investment management 100 described above generally can be implemented using conventional hardware and network communication components and software programming techniques and languages (e.g., such as used for online databases and e-commerce stock trading over the Internet).

In some embodiments, all or portions of the investment management system 100 can be run in a secure data center and/or can be provided as a web or local service to customers. The investment management system 100 can, for example, be developed using a distributed, component-based architecture that can be scaled to accommodate a large number of sessions per day.

The software of the investment management system 100 can, for example, be executed on one or more servers. The servers can communicate over a communication network with client devices such as, for example, a personal computer or PDA. The communication networks can be, for example, the Internet, a mobile phone network, or a local or wide area network. The servers of the investment management system 100 can execute various modules of software to implement one or more of the functions described above. The software modules that can be executed by the investment management system 100 can, for example, be distributed across multiple servers.

By the foregoing description, an improved investment management system 100 and method have been described. The system and method 100 can be substantially or completely web-based such that the user and/or customer can access the system from many computers (e.g., any network device providing, for example, Internet browsing capabilities).

The foregoing description of specific embodiments reveals the general nature of the disclosure sufficiently that others can, by applying current knowledge, readily modify and/or adapt it for various applications without departing from the generic concept. For example, although described primarily in the context of financial assets above (e.g., stocks), the above system can be used to manage other intangible (e.g., intellectual property), real (e.g., land) and/or tangible assets (e.g., commercial airplane leases). Therefore, such adaptations and modifications are within the meaning and range of equivalents of the disclosed embodiments. The phraseology or terminology employed herein is for the purpose of description and not of limitation.

1. A method of managing investments using a computer system, the method comprising:
generating a first plurality of portfolios using a mathematical optimization algorithm with at least one investment theme;
assigning a different weight of the at least one investment theme to each one of the first plurality of portfolios; and
associating each one of the first plurality of portfolios with a theme-based efficient frontier, generating the theme-based efficient frontier by displaying a second plurality of portfolios which provides a representation of forecasted returns based on inherent thematic allocations.

2. The method of claim 1 and further comprising generating an asset-asset correlation matrix for each one of the first plurality of portfolios.

3. The method of claim 1 and further comprising modifying one of the first plurality of portfolios by altering a theme allocation along the theme-based efficient frontier.

4. The method of claim 4 and further comprising using interactive controls to move along a curve representing the theme-based efficient frontier in order to alter the theme allocation.

5. The method of claim 4 wherein altering the theme allocation allows an investor to adjust strategic weightings of theme-based allocations in order to view tradeoffs in overall investment return.

6. The method of claim 1 wherein the at least one investment theme is related to at least one of environmental friendliness, social responsibility, renewable energy, military applications, nuclear power applications, country of origin, corporate governance, and defense industry.

7. The method of claim 1 and further comprising generating buy and sell recommendations and comparing successive buy and sell recommendations.

8. The method of claim 8 and further comprising automatically executing the buy and sell recommendations.

9. An investment management system comprising:
a merchant platform for investment services adapted to be connected to at least two investment service providers,
at least one of the at least two investment service providers generating forecasting information including an asset identification and a forecast,
the merchant platform for investment services using the forecasting information to optimize at least one portfolio.

10. The investment management system of claim 9 wherein the merchant platform for investment services normalizes the forecasting information before optimizing the at least one portfolio.

11. The investment management system of claim 9 wherein historical asset price information is combined with estimated confidence values using a Bayesian method to develop an asset-asset correlation matrix.

12. The investment management system of claim 9 wherein the merchant platform for investment services includes a subscription management module, a contract management module, and a delivery management module.

13. The investment management system of claim 9 wherein the at least two investment service providers includes at least one of a tax service, an asset risk and return forecasting service, an asset attribute information service, a brokerage service, a financial intelligence service, a charting service, a news service, and a data vendor.

14. The investment management system of claim 13 wherein the asset attribute information service provides ratings regarding investment themes including at least one of environmental friendliness, social responsibility, renewable energy, military applications, and nuclear power applications.

15. The investment management system of claim 9 wherein attribute values from the at least two investment service providers are used by the merchant platform for investment services to populate an asset attribute table.

16. The investment management system of claim 9 wherein attribute values from an asset risk and return forecasting service are used by the merchant platform for investment services to populate a service provider forecast table.

17. The investment management system of claim 16 wherein a Bayesian method is used to integrate multiple asset risk and return forecasts into one numerical forecast to populate an integrated forecast table.

18. The investment management system of claim 9 wherein the at least two investment service providers includes at least one free information resource.

19. The investment management system of claim 9 wherein the merchant platform for investment services is adapted to be connected to at least one investor and at least one database.

20. The investment management system of claim 9 wherein an investor inputs initial information into the investment management system including at least one of user personal information, user investing rules, user existing portfolio data, and forecast estimates.

21. The investment management system of claim 9 wherein the at least two investment services providers provide asset specific trade data including at least one of bid/ask pricing, asset ticker, parent exchange, and asset-asset correlation information.

22. The investment management system of claim 9 wherein an investor inputs investment rules into an investment rules interface provided by the merchant platform for investment services.

23. A method of managing investments using a computer system, the method comprising:
providing an investment rules interface to develop exception-based investing rules;
providing an investment rules interface based on asset attributes in which the exception-based investing rules are managed by a user;
providing an asset hierarchy including class levels for each asset;
developing the exception-based investing rules for the class levels by assigning a parent asset attribute for a first class level and assigning a child asset attribute for a second class level; and
generating at least one optimized portfolio based on the exception-based investing rules and the asset hierarchy.

24. The method of claim 23 wherein the asset hierarchy includes assets of at least one of stocks, bonds, real estate, and commodities.

25. The method of claim 23 wherein at least one of the parent asset attribute and the child asset attribute are provided by an investment service provider.

26. The method of claim 23 wherein the exception-based investing rules are developed for specific assets.

27. The method of claim 23 wherein the asset hierarchy is one of a standard asset hierarchy and a thematic asset hierarchy.

28. The method of claim 23 wherein a plurality of exception-based investment rules are developed for one class level.
